(19) United States
(12) Patent Application Publication
(10) Pub. No.: US 2025/0361730 A1
(43) Pub. Date: Nov. 27, 2025

(54) WINGED INSERT FOR ATTACHING TO SLOT OF BOARD AND PLURALITY OF BOARD MOUNTING METHODS THEREOF

(71) Applicant: Matthew Peter KLEIN, SE Calgary (CA)

(72) Inventor: Matthew Peter KLEIN, SE Calgary (CA)

(21) Appl. No.: 18/858,583

(22) PCT Filed: Apr. 14, 2023
(86) PCT No.: PCT/CA2023/050510

§ 371 Date: Oct. 21, 2024

(30) Foreign Application Priority Data
Apr. 19, 2022 (CA) 3155548

(51) Int. Cl. E04F 19/04; E04F 15/02

(52) U.S. Cl. CPC E04F 19/0472; E04F 15/02144

(57) ABSTRACT

A winged insert holds a magnet and includes a flat base having two sides with wings that have U-shape or V-shape. Each side's wing extends off the side of the base in a first direction and then curves back at an outward-facing angle. The wings act similar to barbs or arrow heads to allow the insert to be inserted into a slot on a trim or decking board while preventing the insert from being removed from the slot after insertion. The winged insert may include alignment holes or pins for positioning a removable spacer adjacent the winged insert. The spacer may include a tray or other sidewalls on an opposite side for holding a magnetic conductor. For trim applications, the conductor may be affixed to a wall during an installation process before removing the spacer. For flooring applications, the conductor may be a top metal surface of a joist clip.

### CROSS-REFERENCE TO RELATED APPLICATIONS

This application claims the benefit of priority of Canadian Patent Application No. 3,155,548 filed Apr. 19, 2022, which is incorporated herein by reference.

### BACKGROUND OF THE INVENTION

### (1) Field of the Invention

The invention pertains generally to mounting trim, moldings, decking and other boards to a sub-structure, such as a wall, frame or a plurality of spaced apart studs or joists.

### (2) Description of the Related Art

With respect to trim and moldings, many designs and types of ceiling/wall moldings are found in today's home decorating market. For the non-expert, moldings not only decorate a room, they also hide errors in construction or painting. When first installed, they may hide any uneven painting, particularly adjacent the ceiling or floors, done when either walls or ceilings were first painted. However, when a ceiling or wall needs repainting, the job becomes difficult, since it is not easy to avoid getting paint on the molding.

U.S. Pat. No. 10,927,551 issued Feb. 23, 2021 and entitled, “MAGNETIC ATTACHMENT ASSEMBLY FOR ATTACHING TRIM BOARD TO WALLS CEILINGS AND OTHER SURFACE STRUCTURES” (hereinafter referred to as the “'551 patent”) discloses a plurality of methods of utilizing magnetic attachment assemblies for temporarily attaching boards in trim, moldings, decking, fencing and other applications. Although the techniques in in the '551 patent work well and allow for easy removal of the boards such as for maintenance and renovation work, certain improvements would be beneficial.

For instance, it can sometimes be difficult to pre-attach the magnetic attachment assemblies disclosed in the '551 patent to the slot in the back of the board to be mounted. Adhesively fixing a magnetic conductor such as a piece of thin steel to a bottom of a groove or slot formed in the board complicates manufacture and wastes metal if the conductor runs the entire length of the board. Furthermore, especially for long decking and trim/base boards, the insertion of multiple separate magnetic conductors and/or other magnetic assemblies into the ends of dovetail-shaped slots on the board and then sliding them along the slot into the desired position is both inconvenient and slow. There are also situations such as decking and other outdoor flooring applications where easy removal of floor boards by overcoming the magnetic attraction force of the magnetic assembly is either not required or needs to be prevented. For instance, it may be desirable to make it harder for vandals to remove deck boards.

### BRIEF SUMMARY OF THE INVENTION

According to an exemplary embodiment of the invention there is disclosed a winged insert that holds a magnet and includes a flat base having two sides with wings that have U-shape or V-shape. Each side's wing extends off the side of the base in a first direction and then curves back at an outward-facing angle. The wings act similar to barbs or arrow heads to allow the insert to be inserted into a slot on a trim or decking board while preventing the insert from being removed from the slot after insertion. The winged insert may include alignment holes or pins for positioning a removable spacer adjacent the winged insert. The spacer may include a tray or other sidewalls on an opposite side for holding a magnetic conductor. For trim applications, the conductor may be affixed to a wall during an installation process before removing the spacer. For flooring applications, the conductor may be a top metal surface of a joist clip

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a perspective view of a trim board with a dovetail-shaped slot running lengthwise along the back side of the board according to an exemplary embodiment.

FIG. 2 illustrates an elevational side view of the trim board of FIG. 1.

FIG. 3 illustrates a winged insert for holding one or more magnets and affixing to the slot of the trim board of FIG. 1 according to an exemplary embodiment.

FIG. 4 illustrates a top plan view of the winged insert of FIG. 3.

FIG. 5 illustrates a front elevational view of the winged insert of FIG. 3.

FIG. 6 illustrates a perspective view of a spacer according to an exemplary embodiment.

FIG. 7 illustrates a side elevational view of the spacer of FIG. 6.

FIG. 8 shows an exploded perspective view of a magnetic attachment assembly according to an exemplary embodiment.

FIG. 9 illustrates a perspective view of the magnetic attachment assembly of FIG. 8 in an assembled state ready for use with the layers of FIG. 8 merged together.

FIG. 10 illustrates an elevational side view of the trim board of FIG. 1 before installing the magnetic assembly into the slot.

FIG. 11 illustrates an elevational side view of the trim board of FIG. 1 with the magnetic assembly installed in the slot.

FIG. 12 illustrates a cross sectional view of the trim board and a wall in conjunction with a first step of board installation according to an exemplary embodiment.

FIG. 13 illustrates a cross sectional view of the trim board and a wall in conjunction with a second step of board installation according to an exemplary embodiment.

FIG. 14 illustrates a cross sectional view of the trim board and a wall in conjunction with a third step of board installation according to an exemplary embodiment.

FIG. 15 illustrates a cross sectional view of the trim board and a wall in conjunction with a fourth step of board installation according to an exemplary embodiment.

FIG. 16 illustrates a perspective view of a room including a baseboard installed utilizing a plurality of the magnetic attachment assemblies of FIG. 9.

FIG. 17 illustrates a shaped trim board with an alternative T-slot configuration according to an exemplary embodiment.

FIG. 18 illustrates a plank design baseboard having a dovetail-shaped slot configuration according to an exemplary embodiment.

FIG. 19 illustrates a winged insert with spacer alignment holes and sidewalls according to an exemplary embodiment.

FIG. 20 illustrates a top plan view of the winged insert of FIG. 19.

FIG. 21 illustrates a first perspective view of the spacer showing a first (i.e., winged-insert-facing) side of the spacer.

FIG. 22 illustrates a second perspective view of the spacer showing a second (i.e., magnetic-conductor-facing) side of the spacer.

FIG. 23 illustrates an elevational view of a portion of the spacer showing an alignment pin.

FIG. 24 illustrates a winged insert for use with a decking or other flooring board according to an exemplary embodiment.

FIG. 25 illustrates a cross sectional view of a decking board with T-shaped slot running along a backside of the board according to an exemplary embodiment.

FIG. 26 illustrates how the winged insert of FIG. 24 is inserted into the slot and how the wings hold the insert within the slot once inserted.

FIG. 27 illustrates how the decking board with winged inserts, each holding magnets, is attached to floor joists or studs according to an exemplary embodiment.

FIG. 28 illustrates a perspective view of a locking clip according to an exemplary embodiment.

FIG. 29 illustrates a bottom plan view of an installed floor utilizing the winged inserts and locking clips and shown in FIGS. 24-28 according to an exemplary embodiment.

FIG. 30 illustrates a perspective view of a vice clip for attaching magnets to a decking or other flooring board according to an exemplary embodiment.

FIG. 31 illustrates a perspective view of a locking vice clip for non-magnetically attaching a decking or other flooring board to a joist or stud according to an exemplary embodiment.

FIG. 32 illustrates a top plan view of a decking installation utilizing the vice clips and locking vice clips illustrated above in FIGS. 30 and 31 according to an exemplary embodiment.

FIG. 33 illustrates a perspective view of a winged clip according to an exemplary embodiment.

FIG. 34 illustrates a cross sectional elevation view of the winged clip being mounted in the slot of a decking board and holding the decking board to a joist.

### DETAILED DESCRIPTION

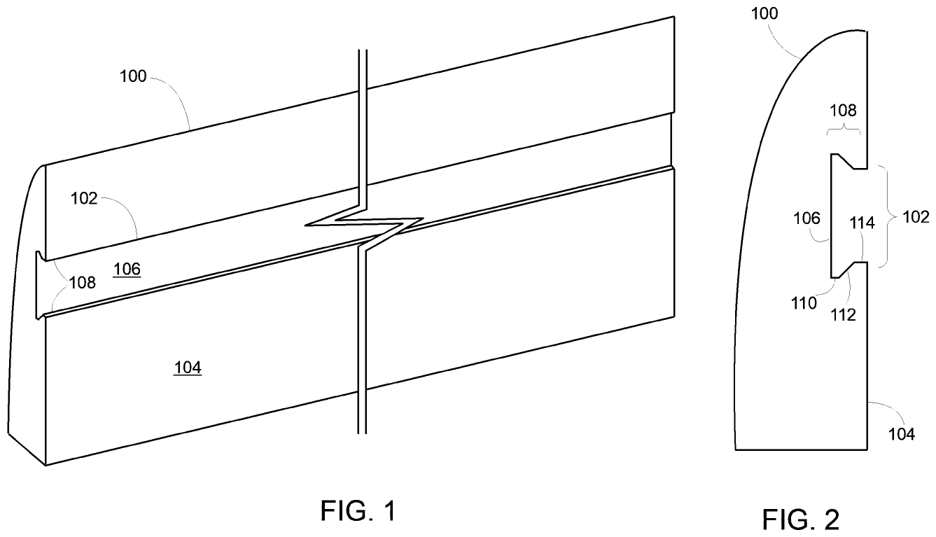

FIG. 1 shows a perspective view of a trim board with a dovetail-shaped slot running lengthwise along the back side of the board according to an exemplary embodiment. FIG. 2 illustrates an elevational side view of the trim board of FIG. 1. As illustrated in FIGS. 1 and 2, the dovetail-shaped slot in this embodiment include a flat base portion with a symmetric sidewall on either side of the slot base. Each of the sidewalls include a first section extending perpendicular from the base of the slot on each side of the slot base, an inwardly angled section forming the dovetail shape, and then a second section again perpendicular with the slot base and extending to the board base. The board may be made of different materials in different embodiment. For instance, in some embodiments, the board is made of cellular Polyvinyl chloride (PVC) and the slot is extruded during manufacture. In other embodiments, the board is made of medium-density fibreboard (MDF) and the slot is cut or milled into the board either during or after the board manufacture.

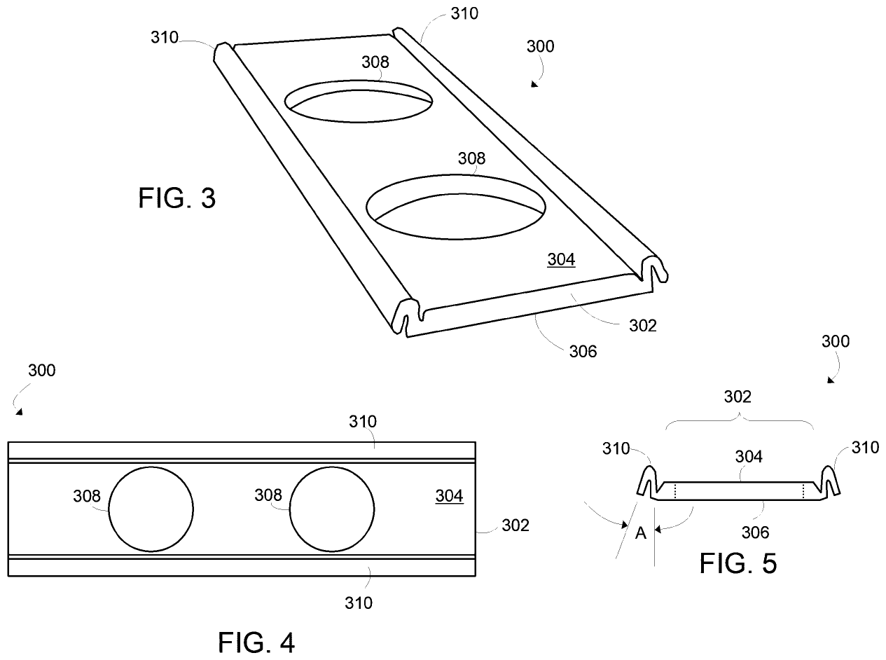

FIG. 3 illustrates a winged insert for holding one or more magnets and affixing to the slot of the trim board of FIG. 1 according to an exemplary embodiment. FIG. 4 illustrates a top plan view of the winged insert of FIG. 3 and FIG. 5 illustrates a front elevational view of the winged insert of FIG. 3. The winged insert includes a flat base having a first (i.e., top) side and a second (i.e., bottom) side. In this embodiment, two circular holes pass through the base for mounting therein two rare earth magnets. The left and right sides of the base have wings that in cross section have an (inverted) U-shape or (inverted) V-shape. On each side, the wing extends off the side of the base in the upwards direction and then curves back downward at an outward-facing angle A of between approximately 20-70 degrees. In some embodiments, the angle A is substantially 45 degrees.

It should also be note that the directional words such as “top”, “bottom”, “upwards”, “downwards”, “left”, “right”, and “inverted” in the above description are merely referring here to the way the insert is illustrated in the figures and do not necessarily refer to the orientation of the part during usage.

The winged insert can be made of different materials in different embodiments. In some embodiments, the insert is made of a strong, rigid material such as polycarbonate or carbon fiber. Different materials may be used in different embodiments, but in preferred embodiments, the material should be selected such that the wings will attempt to keep their shape but still have a certain amount of flex such that the angle A can be reduced by external pressure but will then naturally spring back when the pressure is removed.

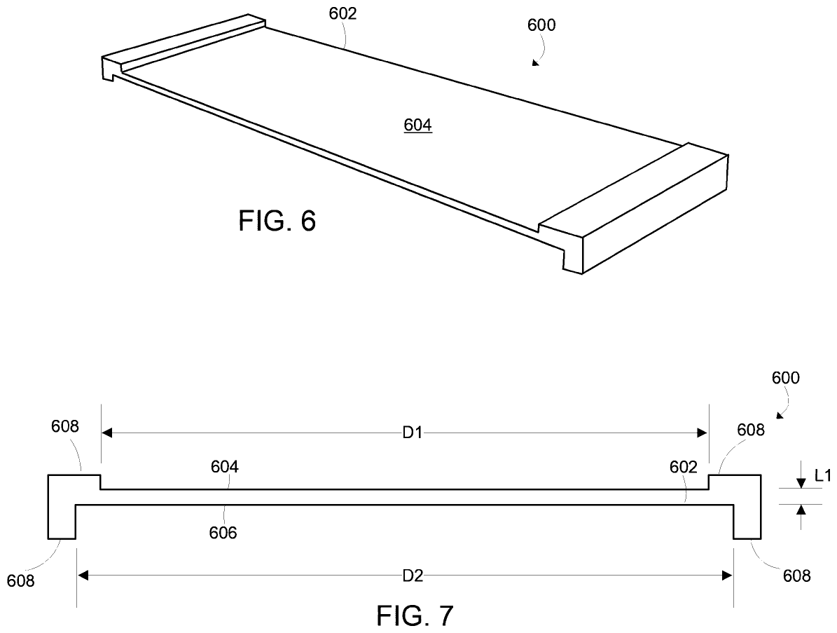

FIG. 6 illustrates a perspective view of a spacer according to an exemplary embodiment and FIG. 7 illustrates a side elevational view of the spacer of FIG. 6. The spacer includes a flat base having top side and bottom side with a thickness of L1. Side walls are provided on both the left and right top sides and the left and right bottom sides. As illustrated, the distance D1 between the sidewalls on the top side may be different than the distance D2 between the sidewalls on the bottom side. As illustrated, the heights (i.e., distance these sidewalls extends from the flat base) may also be different on the top and bottom sides.) The spacer is made of a non-magnetic material that does not feel the attraction of magnets such as wood, plastic, copper, rubber.

Again, it is noted that the directional words such as “top”, “bottom”, “upwards”, “downwards”, “left”, and “right” in the above description are merely referring here to the way the spacer is illustrated in the figures and do not necessarily refer to the orientation of the part during usage.

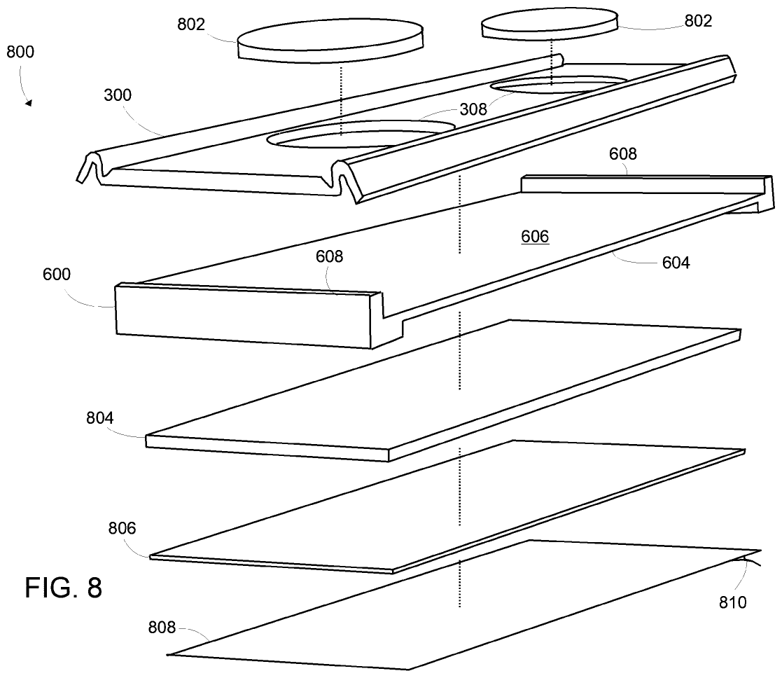

FIG. 8 shows an exploded perspective view of a magnetic attachment assembly according to an exemplary embodiment. Described from the top-most-illustrated layer to the bottom-most-illustrated layer, the magnetic attachment assembly includes the winged insert having two coin-shape rare earth magnets fixedly installed in the circular holes such as by adhesive and/or friction. Below the winged insert, the spacer is mounted such that the winged insert sits lengthwise between left and right sidewalls on a first side of the spacer. Below the spacer, a magnetic conductor such as a metal plate is mounted such that the conductor sits between left and right sidewalls on a second side of the spacer. An adhesive layer such as a double sided tape is affixed to the bottom side of the magnetic conductor (i.e., the side of the magnetic conductor facing away from the spacer). Lastly, a release paper such as waxed paper or other tape backing covers the downward-facing side of the adhesive layer. The release paper includes a pull tab on at least one corner to facilitate a user removing the release paper to thereby expose the adhesive layer for usage.

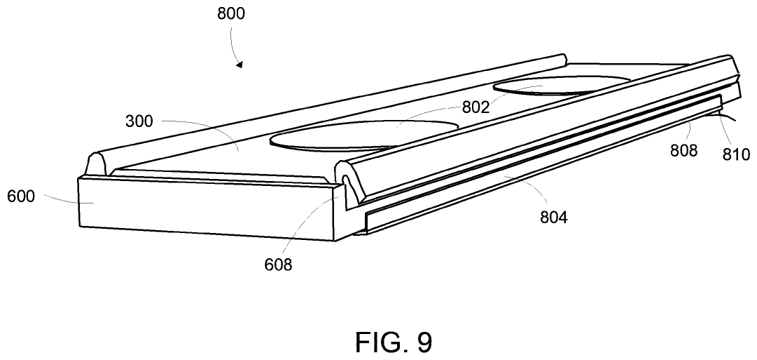

FIG. 9 illustrates a perspective view of the magnetic attachment assembly of FIG. 8 in an assembled state ready for use with the layers of FIG. 8 merged together. In this state, the magnets and magnetic conductor in combination possess an attractive magnetic property pulling each toward one another. The thickness of the spacer holds the conductor a predetermined distance L1 away from the winged insert having the magnets. The predetermined distance L1 does not prevent the attractive magnetic property from overcoming forces of gravity on the magnetic conductor such that the conductor is magnetically held in this initial position adjacent the winged insert with the spacer frictionally held therebetween. The various sidewalls of the spacer help ensure that the magnetic attachment assembly stays together as a unit and help ensure that the spacer does not slip out between the winged insert and magnetic conductor during transport or other situations where vibrations may be experienced.

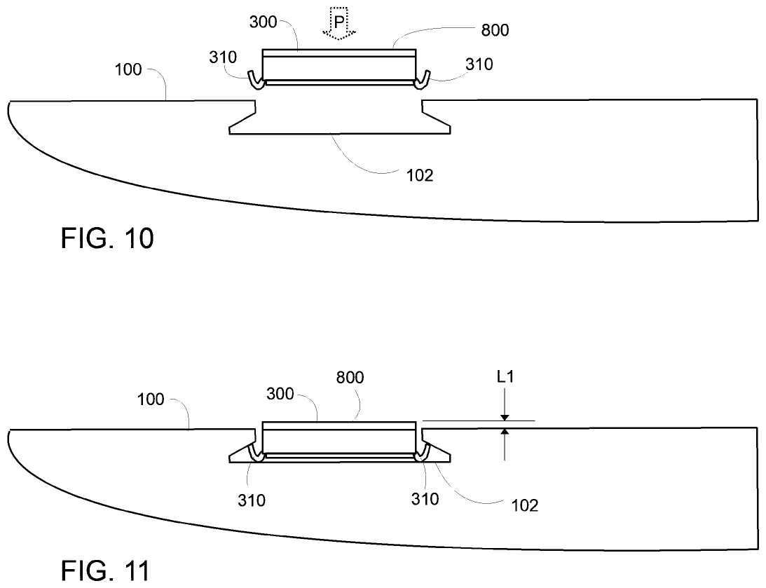

FIGS. 10 and 11 together illustrate a method of installing the magnetic attachment assembly of FIG. 8 into the slot at an arbitrary position on the back of a trim board such as illustrated in FIG. 1. In particular, FIG. 10 illustrates an elevational side view of the trim board of FIG. 1 before installing the magnetic assembly into the slot, and FIG. 11 illustrates an elevational side view of the trim board of FIG. 1 with the magnetic assembly installed in the slot. Installation of the magnetic assembly involves the user orientating the magnetic assembly relative to the slot as shown such that the wings of the insert act like barbs or arrow heads pointing toward the slot. The wings in this orientation allowing the magnetic attachment assembly to be inserted into the slot by pressure P applied by a user pushing on the insert as illustrated in FIG. 10. The wings deflect inward slightly and slide past the narrower opening of the slot. Once into the slot, as shown in FIG. 11, the wings open back up and will catch on the dovetail shape of the slot and hold the magnetic assembly captive even if a backward force is applied.

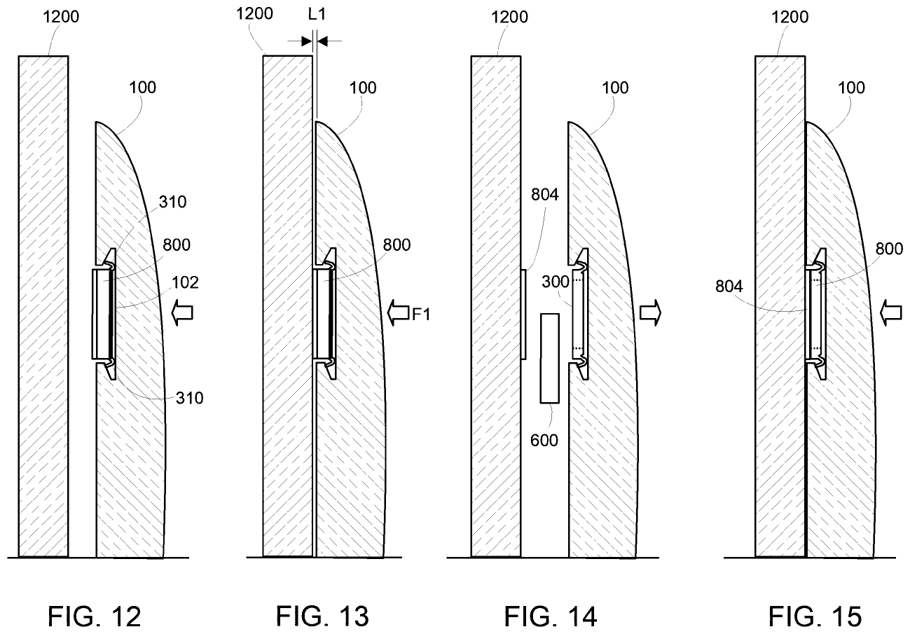

FIGS. 12-15 illustrates a cross sectional view of the trim board and a wall in conjunction with a method of installing the magnetic conductor to a correct position on the wall by utilizing the removable spacer between the magnets of the winged insert and the magnetic conductor according to an exemplary embodiment.

The installation process starts by inserting the magnetic attachment assembly into the slot of the trim board as described above and in conjunction with FIGS. 10 and 11. As shown in FIG. 12, in the starting position, the wings of the magnetic attachment assembly hold the winged insert in position, and the magnets are positioned adjacent the magnetic conductor with the removable spacer intermediate the conductor and the magnets. The conductor and the magnets in combination possess an attractive magnetic property pulling each toward one another. The removable spacer holds the conductor a predetermined distance L1 away from the conductor. The predetermined distance L1 does not prevent the attractive magnetic property from overcoming forces of gravity on the magnetic conductor. In this way, prior to attaching the magnetic conductor to the wall, the conductor is magnetically held in an initial position adjacent the winged insert with the removable spacer frictionally held therebetween.

Once the magnetic attachment assembly is configured in the position shown in FIG. 12, the installation process is ready to be performed. The end user removes the release paper from the adhesive by pulling the tab and pushes the trim board toward the wall at the desired position and alignment as shown in FIG. 13. The adhesive layer affixed on the wall-facing side of the magnetic conductor is pushed against the wall. As the user pushes, the adhesive layer bonds to the wall and thereby attaches the magnetic conductor to the wall 14. As shown in FIG. 13, there is a space having width of substantially L1 between the trim board and the wall, which corresponds to the thickness L1 of the spacer.

FIG. 14 illustrates the situation at a next portion of the installation process. At this step, the user pulls the trim board away from the wall to thereby overcome the attractive magnetic property and pull the winged insert with magnets away from the magnetic conductor, which is now securely attached to the wall. Because of the inclusion of the spacer, the magnets and the conductor are already separated by distance L1 and the magnetic force is easier to overcome by the user and also reducing forces exerted on the adhesive.

As shown in FIG. 14, after the trim board with winged insert is pulled away from the magnetic conductor fixed to the wall, the user removes the spacer from between the magnets and the magnetic conductor. In some embodiments, the spacer is a non-ferromagnetic material such as plastic such that it will simply fall away when the trim board is pulled away from the wall. The user may thereby easily reach between the trim board and wall to grab the spacer for removal.

FIG. 15 illustrates a cross section of the installed trim board and wall. After the spacer is removed, the user pushes the trim board toward the wall and the attractive magnetic property of the magnets pulls the winged insert against the magnetic conductor thereby securely attaching the trim board to the wall. Since the spacer has now been removed, the magnets in the winged insert are now directly against the conductor providing the maximum magnetic forces for holding the trim to the wall.

Another benefit of the above-described installation process including the use of the spacer is to facilitate a strong bond of the adhesive to the correct position on the wall. As illustrated in FIG. 13, the slot depth in the trim board and various widths of the components of the magnetic attachment assembly including the thickness of the spacer may be such that the wall-facing side magnetic conductor sits proud ahead of the front side of the trim board by a distance of approximately L1, i.e., the thickness of the spacer. In this way, when the user pushes the trim board against the wall in the configuration of FIG. 13, only the front, wall-facing adhesive side of the magnetic conductor is in contact with the wall. As such, the user's entire force F1 helps to form a strong adhesive bond between the magnetic conductor and the wall.

The distance L1 corresponds to the width of the spacer in this embodiment. Thus, after the spacer is removed and the trim board is attached to the wall in the finished configuration as shown in FIG. 15, the distance L1 is now removed from the magnetic attachment assembly, and, beneficially, there is no gap between the trim board and the wall. The aesthetic appeal of the installation is thereby increased.

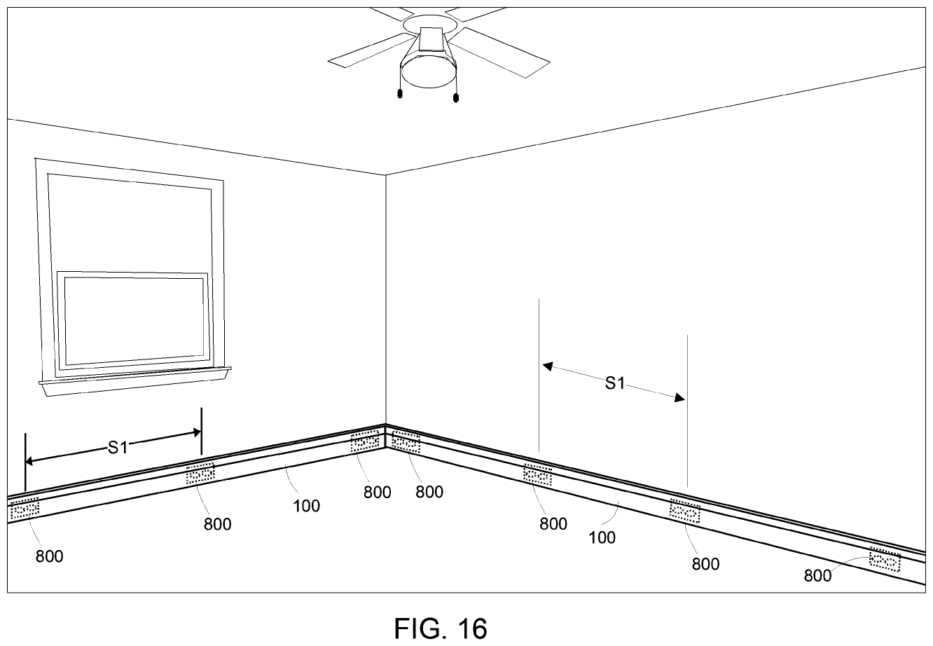

FIG. 16 illustrates a perspective view of a room including a baseboard installed utilizing a plurality of the magnetic attachment assemblies of FIG. 9. A single trim board has a plurality of magnetic attachment assemblies installed therein. Since each magnetic attachment assembly can be installed at any arbitrary point along the trim board by simply inserting the magnetic attachment assembly using the above-described process of FIGS. 10 and 11, especially for long trim boards installation speed is increased. The installer may simply insert a desired number of magnetic attachment assemblies at the desired positions with any desired separation distance S1 therebetween. The separation distance S1 may in some embodiments be between 2 to 3 feet. For low traffic areas such as in closets a longer separation distance of 3 feet may be utilized. Alternatively, for higher traffic areas, one magnetic attachment assembly be installed every 2 feet along the trim board.

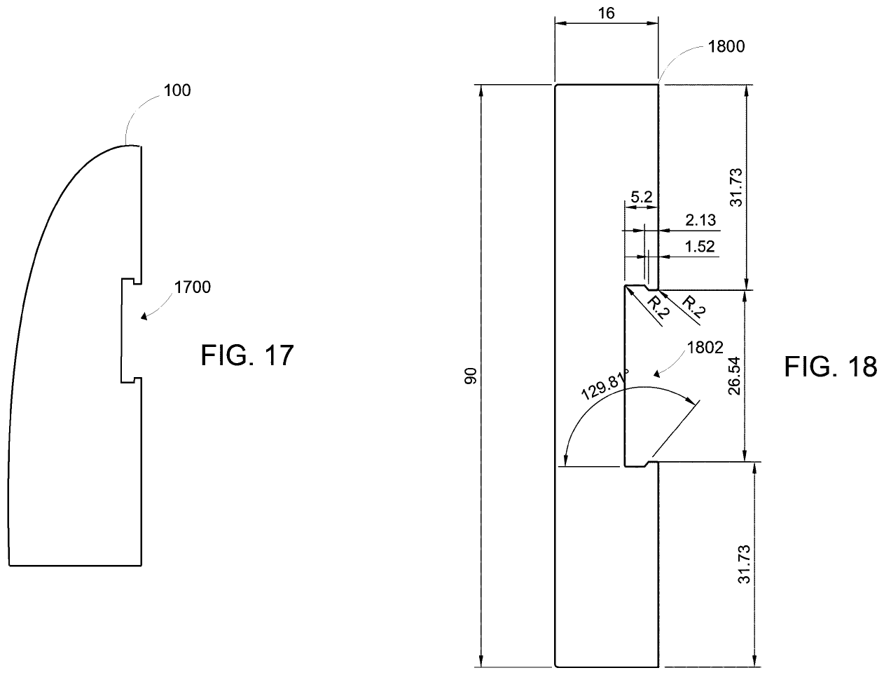

FIG. 17 illustrates a shaped trim board with an alternative T-slot configuration according to an exemplary embodiment. Like the dovetail-shaped slot described above for FIG. 2, the T-shaped slot of FIG. 17 also provides a narrower ridge at the opening of the slot for the ends of the winged insert to act as barbs or arrow heads to hold the winged insert captive within the slot after insertion.

FIG. 18 illustrates a plank design baseboard having a dovetail-shaped slot configuration according to an exemplary embodiment. The dimensions illustrated in FIG. 18 give a specific embodiment for an appealing and modem style plank baseboard that may be suitable for residential and professional applications. Also illustrated in FIG. 18 is that the dovetail shape of the slot may also be fairly minimum (very close to simply a rectangular slot) while still giving ample surface for the ends of the wings of the winged insert to engage after insertion to the slot. In general, any slot shape that has a narrower width for the ends of the wings to squeeze past during insertion and then abut against to prevent removal will work well for a secure fit.

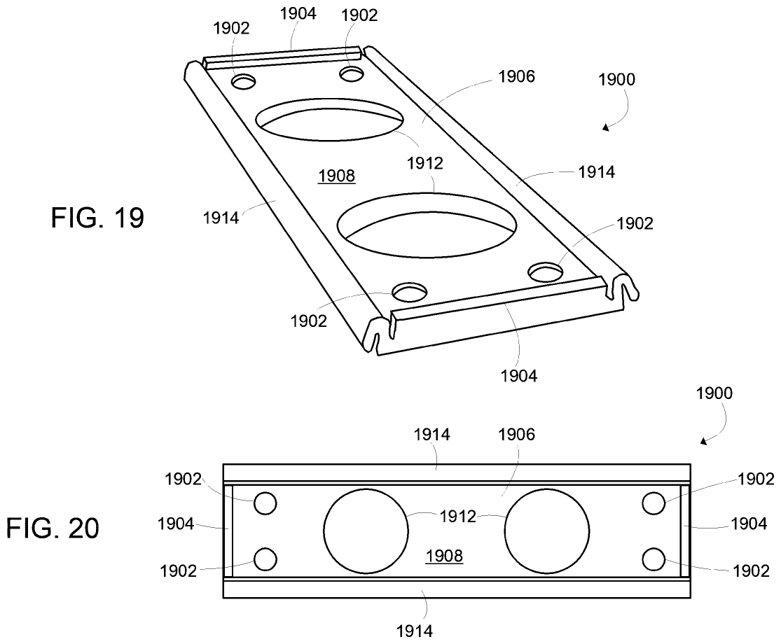

FIG. 19 illustrates a winged insert with spacer alignment holes and sidewalls according to an exemplary embodiment. FIG. 20 illustrates a top plan view of the winged insert of FIG. 19. Similar to the previously described winged insert (of FIG. 2), the winged insert of this embodiment includes a flat base having a first (i.e., top) side and a second (i.e., bottom) side. Two circular holes pass through the base for mounting therein rare earth magnets. The left and right sides of the base have wings that in cross section have an (inverted) U-shape or (inverted) V-shape. Furthermore, unlike the earlier embodiment of FIG. 2, the base of the winged insert in FIGS. 19 and 20 includes a plurality of four spacer alignment holes and left and right sidewalls extending off the first (i.e., top) side of the base.

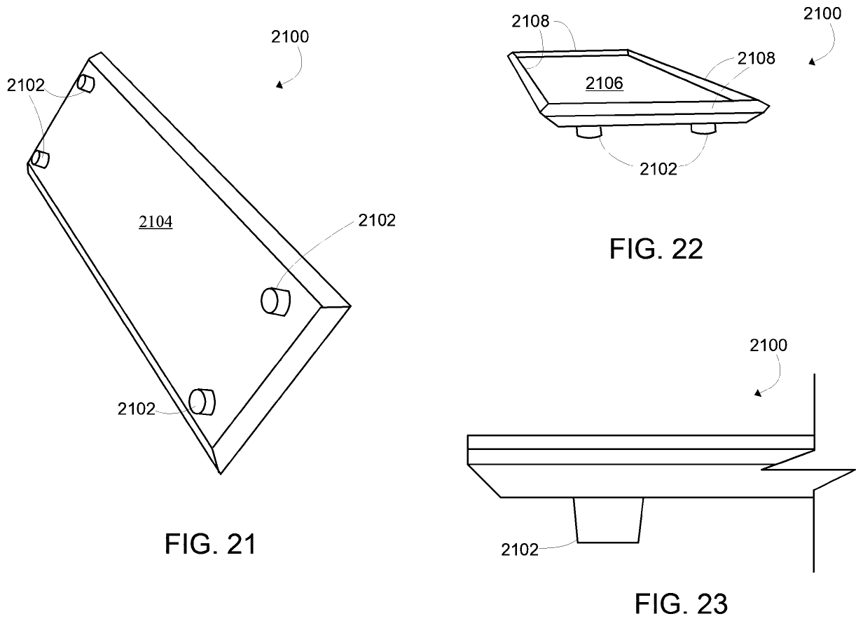

FIGS. 21-23 illustrate a spacer with alignment pins for use with the winged insert of FIG. 19 according to an exemplary embodiment. FIG. 21 illustrates a first perspective view of the spacer showing a first (i.e., winged-insert-facing) side of the spacer, FIG. 22 illustrates a second perspective view of the spacer showing a second (i.e., magnetic-conductor-facing) side of the spacer, and FIG. 23 illustrates an elevational view of a portion of the spacer showing an alignment pin.

As illustrated in FIG. 21, the spacer has four alignment pins protruding from the base for entering into the corresponding four alignment holes on the base of the winged insert. The sidewalls of the winged insert further help hold the spacer in position. As illustrated in FIG. 22, the other side of the spacer has four sidewalls around the perimeter of the spacer base thereby forming a tray for holding a magnetic conductor therein.

A benefit of the of the winged insert and spacer embodiment shown in FIGS. 19-23 is that the magnetic attachment assembly formed therebetween when they are sandwiched in layers such as shown in FIGS. 8 and 9 better resists slippage of the spacer and/or relative positions of the winged insert and magnetic conductor during transport and movement. Whereas the earlier-described embodiment of FIGS. 3-9 works well in many applications—the magnetic attachment assembly shown in FIG. 8 only has slip prevention features in the lengthwise direction. For best alignment, it may require an installer to laterally pinch the magnetic attachment assembly between two fingers to ensure the spacer and magnetic conductor are well-aligned with the winged insert before attaching the trim board to the wall. In contrast, in the embodiments of FIGS. 19-23, the structure of the winged insert and spacer ensures that the spacer is properly aligned with the winged insert and further ensures that the magnetic conductor is properly aligned with the spacer. In this way, speed of installation may be improved without requiring the installer to manually ensure full alignment before attaching the trim board to the wall.

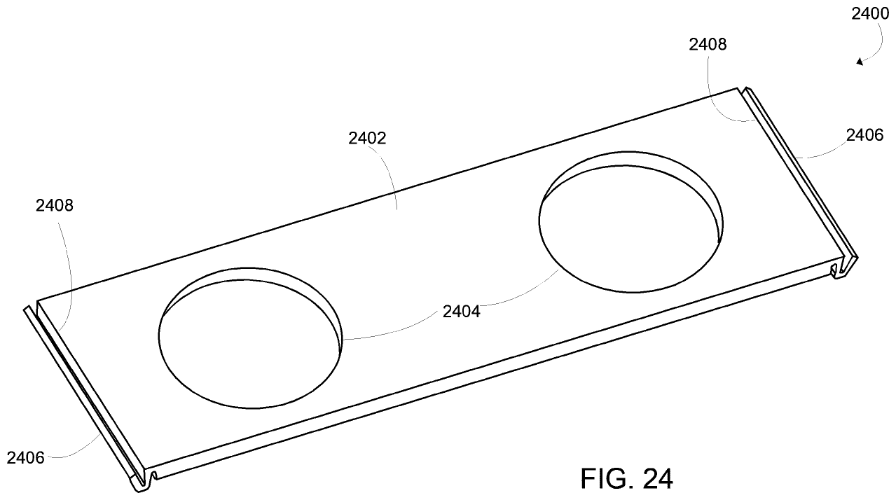

FIG. 24 illustrates a winged insert for use with a decking or other flooring board according to an exemplary embodiment. The winged insert of FIG. 24 is similar to that of FIG. 3 including a base with holes for mounting magnets. A difference with the winged insert of FIG. 24 is that the wings are now moved to be on the shorter sides of the base. This change is to facilitate insertion of the winged insert into a decking or other flooring board with a much wider slot to ensure a solid magnetic attraction to joist or studs that run perpendicular to the board.

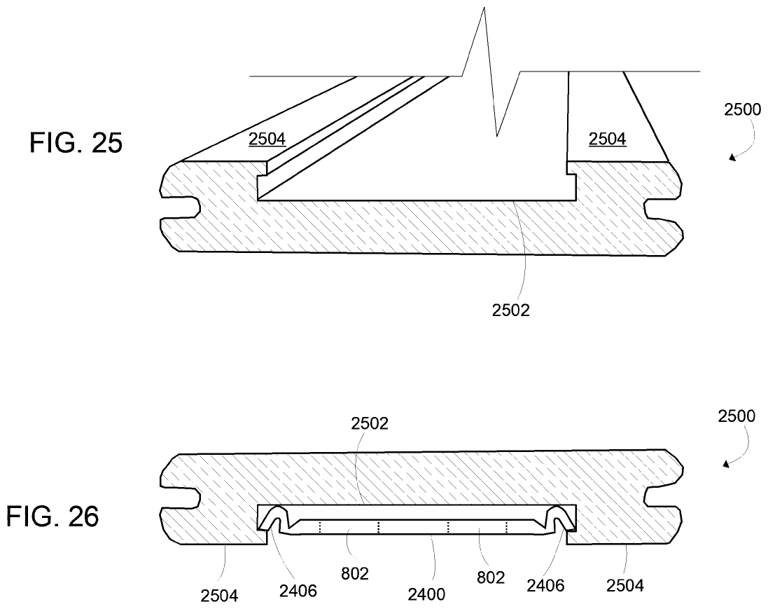

FIG. 25 illustrates a cross sectional view of a decking board with T-shaped slot running along a backside of the board according to an exemplary embodiment. In this embodiment, the slot is cut or milled into the board (or extruded during board manufacture) and has a T-shape.

FIG. 26 illustrates how the winged insert of FIG. 24 is inserted into the slot and how the wings hold the insert within the slot once inserted. The winged insert at this point includes the rare earth magnets affixed within the holes and the insertion technique is very similar to as described above for FIGS. 10 and 11 and therefore a repeated description is omitted for brevity. A plurality of winged inserts (each with respective magnets) may be inserted at a corresponding plurality of positions along slot of the decking board in a similar manner.

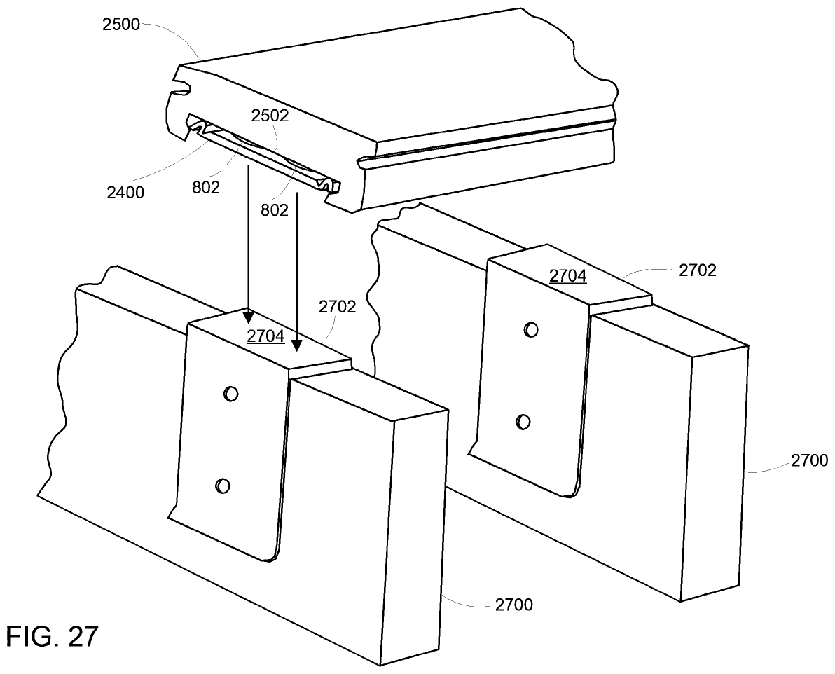

FIG. 27 illustrates how the decking board with winged inserts, each holding magnets, is attached to floor joists or studs according to an exemplary embodiment. In this embodiment, metal U-shaped clips are mounted to the joists as illustrated and their top surfaces act as magnetic conductors. In some embodiments, additional magnetic conductors may be mounted to the top surfaces of the clips; however, many existing metal U-shaped clips are available on the market and may be used as magnetic conductors without modification.

The decking board is orientated perpendicular to the joists such that the slot with winged insert is facing down toward the top surfaces of the U-shaped clips. The spacing of the plurality of winged inserts with magnets in the slot of the decking board is made to match the separation distance of the joists so that, when the board is laid across the joists, each winged insert will align with a metal clip. The magnets in the winged inserts thereby attract to the metal conductors on the top surfaces of the U-shaped clips and the decking board is held in position.

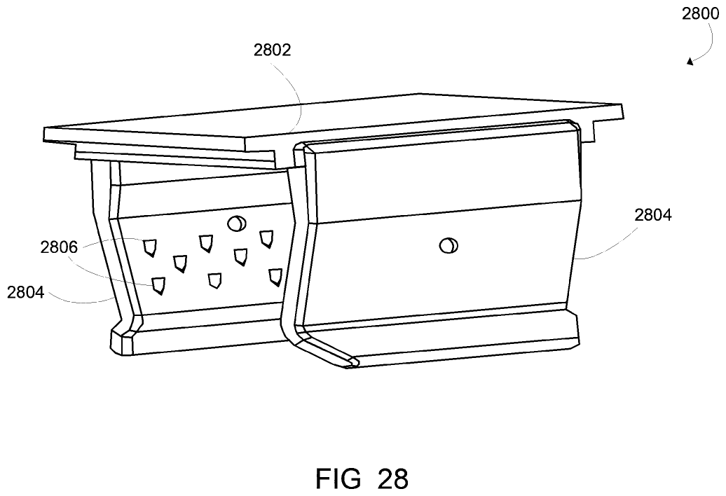

FIG. 28 illustrates a perspective view of a locking clip according to an exemplary embodiment. In some applications such outdoor decking and flooring applications, it may be desirable to allow for the convenient removal and replacement of the decking or flooring boards during renovations and maintenance by authorized workers, but still prevent vandals from easily removing the boards during other times. The locking clip facilitates this by including a top surface that has a T-shape to correspond with the T-shaped slot on the board. In other embodiments, the board may have a dovetail shape and the locking clip top surface may have a corresponding dovetail shape.

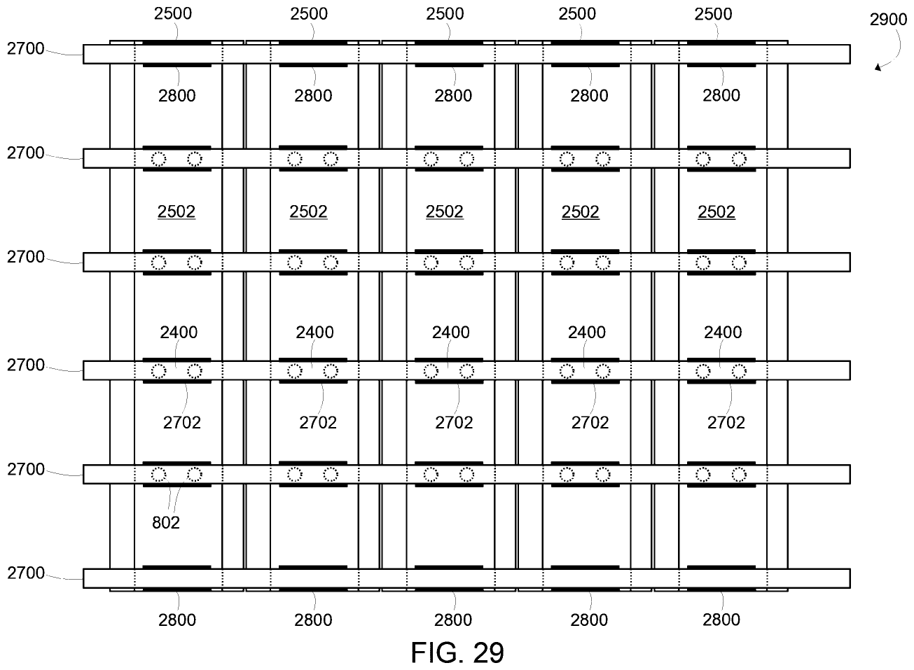

FIG. 29 illustrates a bottom plan view of an installed floor utilizing the winged inserts and locking clips and shown above in FIGS. 24-28 according to an exemplary embodiment. In the diagram, the floor joists run horizontally whereas the decking boards run vertically. At each of middle cross points between the decking boards and the joists (i.e., not at the ends of the decking boards), there is a winged insert installed in the decking board slot and a corresponding metal clip installed on the joist board. The magnets in the winged insert attract and hold to the metal top surface of the clip and thereby magnetically hold the decking board to the joists. To prevent a vandal from simply lifting the decking board off the joists by overcoming the magnetic force of these winged inserts, locking clips are utilized at each end of the decking boards to thereby more permanently secure the decking boards at their ends. A respective locking clip as illustrated in FIG. 28 is inserted at both ends of the decking board and is attached to a joist by way of the inward angled clip-arms and locking teeth. One or more additional screws may also be used to secure the clip side arms to the joist for extra security if needed.

During renovation and maintenance, it is still easy for authorized personal to remove the decking boards by simply removing the locking clips at each end of the decking board. Thereafter, the entire board can be conveniently removed and later replaced easily by simply pulling apart and then bringing together the magnetic attachments of the winged inserts and metal clips.

In other embodiments, if security of the boards is not needed, the locking clips in the above installed floor embodiment may be replaced with winged inserts thereby facilitating easy removal of decking boards without the need to first manually remove the locking clips at each end.

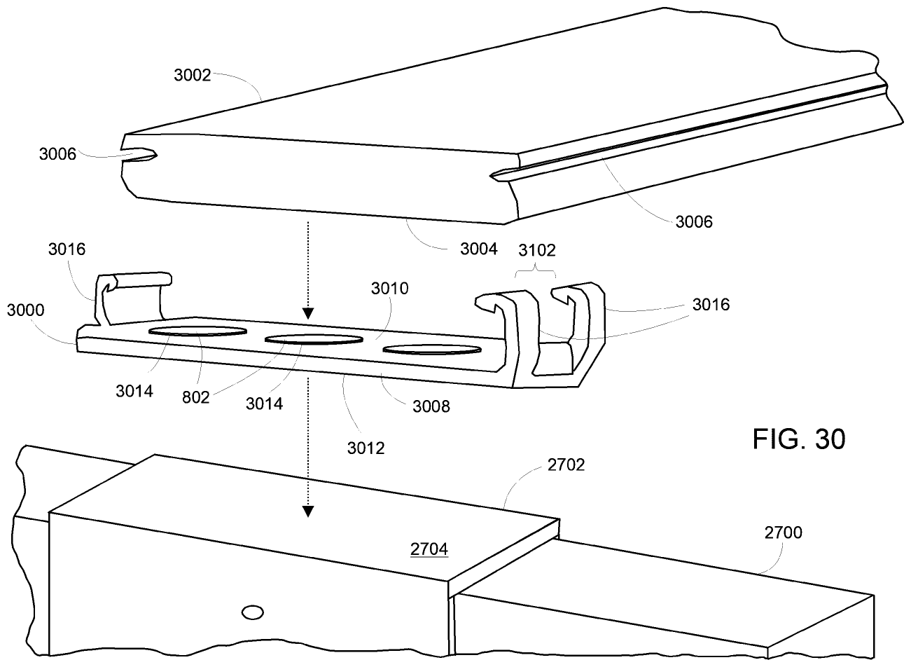

FIG. 30 illustrates a perspective view of a vice clip for attaching magnets to a decking or other flooring board according to an exemplary embodiment. In this embodiment, the decking or flooring board does not have a slot running down the backside of the board. Instead, it has side slots running lengthwise along the sides of the board. Many existing decking and flooring boards available on the market already come with these side slots in place. The vice clip leverages these side slots to attach magnets to the underside of the boards for magnetic attachment to metal clips on the joists/studs. The vice clip includes a base with first (i.e., top) side and second (i.e., bottom) side. A plurality of holes are provided through the base for mounting therein one or more rare earth magnets. Curved side walls on left and right sides of the vice clip extends upward and curve inward for insertion into the side slots on the decking or flooring board to be mounted.

A method of decking installation involves attaching a plurality of vice clips along the underside of the decking board and spaced according to the joist separation distance. The decking boards can then be laid across the joists and the magnetic attraction of the magnets in the vice clip and the top surfaces of the metal clip hold the decking boards secure to the joists.

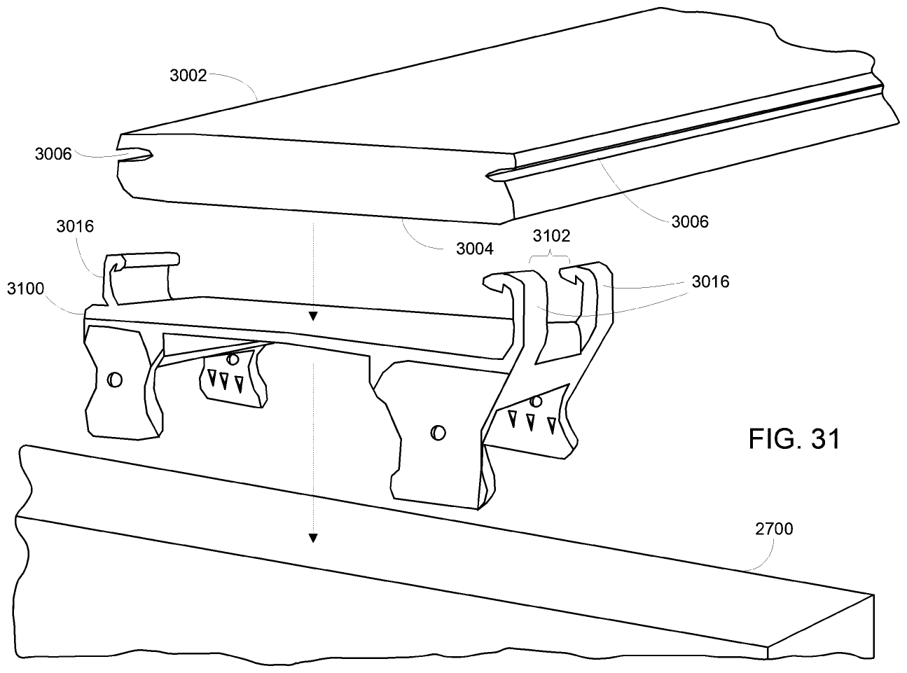

FIG. 31 illustrates a perspective view of a locking vice clip for non-magnetically attaching a decking or other flooring board to a joist or stud according to an exemplary embodiment. Similar to FIG. 30, the locking vice clip of FIG. 31 includes the a top-side structure of curved sidearms extending off the right and left sides for attaching into the side slots of the decking board. However, on the underside of the locking vice clip a plurality of inward angled clip-arms and locking teeth on the inner surfaces thereof. One or more screw holes may also be provided on the clip-arms for facilitating attachment of the vice clip-arms to the joist/studs.

As shown in both FIGS. 30 and 31, the curved arms on the top side of the vice-clip are different on the left and right side and are therefore not symmetric. On a first side (e.g., left side in FIGS. 30 & 31), there is one curved arm which is position in a center of the side. On a second side (e.g., right side in FIGS. 30 & 31), there are two curved arms which are positioned on either side of the center area with the center area being empty. The reason for this design is so that a plurality of vice clips may be placed adjacent to one another along a single joist board and they will interlock with each other (i.e., not interfere which each other). In other words, when two vice clips are placed side by side on a single joist, the single center curved arm on the left side of a first vice clip will fit in the space between the two curved arms on the right side of a second vice clip.

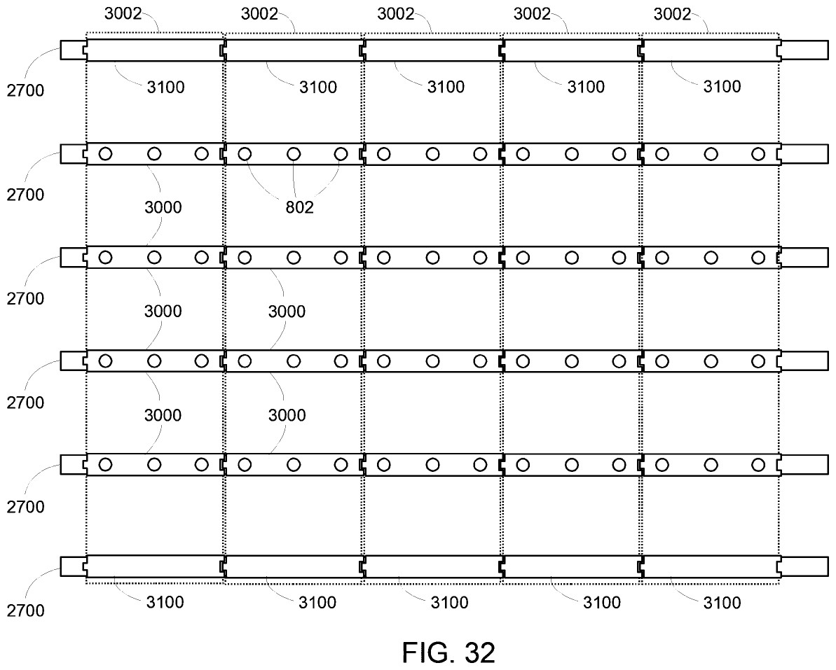

FIG. 32 illustrates a top plan view of a decking installation utilizing the vice clips and locking vice clips illustrated above in FIGS. 30 and 31 according to an exemplary embodiment. The joists boards run horizontally in the figure and the decking boards (shown in dotted lines) run vertically. The locking vice clips are at the ends of the decking boards to more permanently attach the decking boards to the joists at the deck board ends. At the intersection points between the decking boards and the joists in the middle areas of the decking boards, the vice clips with magnets are used to magnetically attach the deck boards to the joists at these positions.

Again, if locking is not desired, in an alternative embodiment, the locking vice clips may be replaced with vice clips having magnets to thereby facilitate easier removal of the decking boards for maintenance and renovation.

It should also be mentioned that locking vice clips may solely be used in some installations if there is no desire for easy removal of the decking boards. In other words, in some embodiments, the deck boards are mounted to the joists only using locking vice clips at each joist intersection and therefore are considered permanently mounted to the joists. In this way, a plurality of locking vice clips may also be utilized to mount a decking or other flooring board with side slots to a joists in a permanent installation.

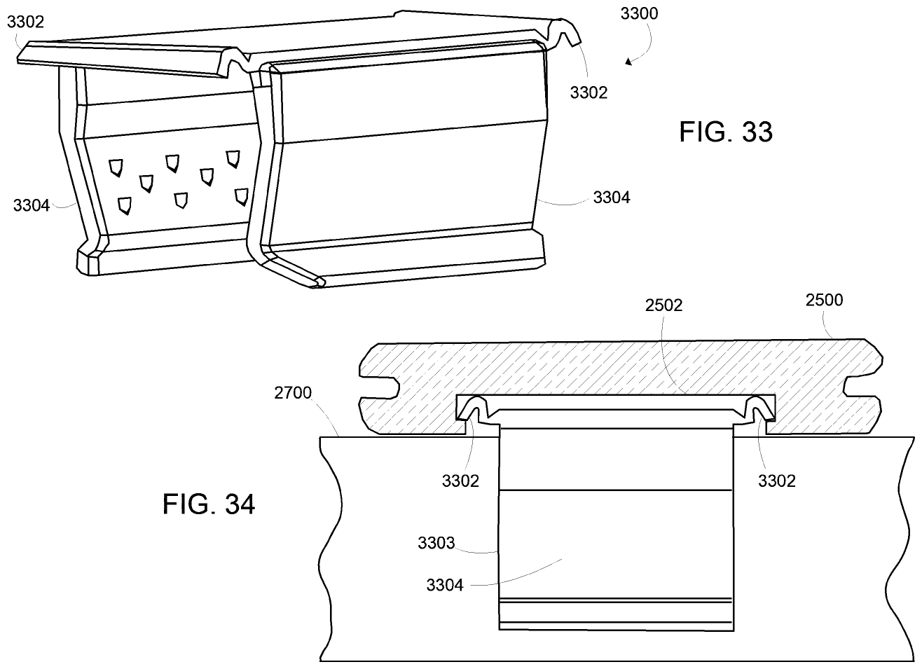

FIGS. 33 and 34 illustrate a winged clip for permanently mounting a decking or other flooring board that has a backside slot to a joist or stud according to an exemplary embodiment. In particular, FIG. 33 illustrates a perspective view of a winged clip according to an exemplary embodiment and FIG. 34 illustrates a cross sectional elevation view of the winged clip being mounted in the slot of a decking board and holding the decking board to a joist.

The winged clip is essentially the winged insert of FIG. 24 being merged onto the top surface of the locking clip of FIG. 28. By the integration of these components, rather than having the T-shaped top surface (or dovetail top surface in other embodiment), the winged clip includes side wings that act as barbs or arrow heads for insertion into the board slot. The benefit of the side wings is that they allow the winged clip to be inserted into the slot at any arbitrary position along the slot and do not need to be slid along the slot as would be required to attach the locking clip of FIG. 28 in the middle of a decking board.

Beneficially, once inserted, the winged clips can still have minor position adjustments by sliding along the slot. Thus, the winged clip of FIGS. 33 and 34 is well suited to applications where the decking board is desired to be permanently attached to the studs. A plurality of winged clips can be inserted into the slot, each spaced according to the joist spacing. Then the deck board can be laid of the joists and the inwardly angled arms of the winged insert will grips the joists and hold the board secure. Further locking screws may be screwed through the screw holes for additional security if desired.

Although the invention has been described in connection with preferred embodiments, it should be understood that various modifications, additions and alterations may be made to the invention by one skilled in the art without departing from the spirit and scope of the invention.

For instance, although the above embodiments have focused on the magnets being located on winged insert or vice clip that is secured to the board to be mounted while a magnetic conductor is mounted on the wall or joints/stud, it should be noted that in other embodiments these component locations may be reversed. In other words, the magnets may be secured to the wall or joist such as on a strip adhesively attached to the wall or mounted within the top surface of a clip attached to the joist/stud. Likewise, the magnetic conductor may be inserted within or otherwise attached to a slot of the board to be mounted. Generally speaking, both the magnets and the magnetic conductor are ferromagnetic devices that together possess an attractive magnetic property that pulls each toward one another. For instance, in the illustrated examples, the magnets mounted on the winged insert or vice clip are a first ferromagnetic device that is attached to a trim board or other object that is desired to be attached to a surface such as a wall our joist. The magnetic conductors are a second ferromagnetic device. In general, these two ferromagnetic devices experience magnetic forces pulling each other toward one another and may therefore be swapped in relative positions with each other in different embodiments.

Likewise, in other embodiments, two separate magnets may be utilized as first and second ferromagnetic devices as long as they are configured in the correct orientation such that they experience an attractive magnetic property, for instance, South-pole to North-pole or vice versa. Of course, two ferromagnetic devices such as steel plate magnetic conductors would not experience any attractive magnetic property between them without the presence of an additional permanent magnet so two conductors would not be sufficient to pull toward one another unless one is magnetized to a sufficient degree.

Although examples of inserts and clips shown above have been shown to hold two or three coin-shaped rare earth magnets, the number of magnets utilized and their types and shapes may be changed in other embodiment. Different numbers of permanent magnets may be held by a single winged inserts, for example. Likewise, a different form factor of one or more magnets other than coin-shaped magnets may be used—for example, the entire base of the winged insert or the magnetic conductor may itself be a magnet in some embodiments.

Although applications such as mounting trim boards and molding to walls and mounting decking and other flooring boards to joists/studs have been shown, other embodiments and applications may also take advantage of the illustrated technology. For instance, vertical or horizontal wall and fence boards may also be mounted in a similar manner.

The illustrated T-slot and dovetail slots and groove may be swapped with each other in other embodiments where T-slots shaped are used instead of dovetail shaped or vice versa. Likewise, other milling grooves and slot shapes may be utilized in other embodiments in a similar manner. Although slot shapes that have a narrower width for the ends of the wings to squeeze past during insertion and then abut against to prevent removal are preferred for a secure fit of the winged insert, in some embodiments, rectangular slot shapes will also work. This is because the surface of the board itself may have high friction (e.g., rough wood) and the ends of the wings will dig into this slot sidewalls and prevent removal of the winged insert even if the slot sidewalls are simply straight.

Combinations of the alignment techniques of the spacer/winged insert shown above may be used. For instance, the spacer of FIG. 6 may include a four side walls on one or both sides for alignment with the magnetic conductor and/or winged insert. Likewise, the spacer of FIG. 6 may include alignment pins for aligning with alignment holes on the winged insert similar to as shown in FIGS. 19-23. Furthermore, the above-described and/or illustrated embodiments may also have the positions of the alignment holes and pins reversed such that an alignment hole is replaced with an alignment pin and vice versa.

The method steps and described and/or shown above are not restricted to the exact order shown, and, in other configurations, shown steps may be omitted or other intermediate steps added.

In an advantage embodiment, a winged insert holds a magnet and includes a flat base having two sides with wings that have U-shape or V-shape. Each side's wing extends off the side of the base in a first direction and then curves back at an outward-facing angle. The wings act similar to barbs or arrow heads to allow the insert to be inserted into a slot on a trim or decking board while preventing the insert from being removed from the slot after insertion. The winged insert may include alignment holes or pins for positioning a removable spacer adjacent the winged insert. The spacer may include a tray or other sidewalls on an opposite side for holding a magnetic conductor. For trim applications, the conductor may be affixed to a wall during an installation process before removing the spacer. For flooring applications, the conductor may be a top metal surface of a joist clip.

Functions of single components may be separated into multiple components, or the functions of multiple components may be combined into a single component. All combinations and permutations of the above described features and embodiments may be utilized in conjunction with the invention.

1. A winged insert for holding a magnet, the winged insert comprising:
a flat base having a first side and a second side opposite the first side together forming a pair of opposing sides, the pair of opposing sides having a corresponding plurality of wings wherein each of the pair of opposing sides has a wing extending therefrom, the flat base having one or more magnet holding holes for holding the magnet and further having one or more alignment holes for positioning a removable spacer adjacent the flat base;
a first of the wings extending from the first side in a first direction and curving back in a first reverse direction at least partially opposite the first direction with a first outward-facing angle away from the flat base; and
a second of the wings extending from the second side in a second direction and curving back in a second reverse direction at least partially opposite the second direction with a second outward-facing angle away from the flat base.

2. The winged insert of claim 1, wherein each of the wings have a U-shape.

3. The winged insert of claim 1, wherein each of the wings have a V-shape.

4. The winged insert of claim 1, wherein the wings acts as barbs or arrow heads to allow the winged insert to be inserted into a slot on a trim or flooring board while preventing the winged insert from being removed from the slot after insertion.

5. The winged insert of claim 1, wherein the first outward-facing angle and the second outward facing angle are each between 20-70 degrees.

6. The winged insert of claim 1, wherein the first outward-facing angle and the second outward facing angle are each 45 degrees.

7. The winged insert of claim 1, wherein:
the flat base is rectangular having a length longer than a width; and
the first of the wings and the second of the wings respectively extend from the pair of opposing sides along the length of the flat base.

8. The winged insert of claim 1, wherein:
the flat base is rectangular having a length longer than a width; and
the first of the wings and the second of the wings respectively extend from the pair of opposing sides along the width of the flat base.

9. The winged insert of claim 1, wherein the flat base further comprises a pair of sidewalls extending off a second pair of opposing sides of the flat base, the second pair of opposing sides of the flat base being different than the pair of opposing sides from which the corresponding plurality of wings extend.

10. A magnetic attachment assembly comprising the winged insert of claim 1, and further comprising the removable spacer adjacent the flat base; wherein the removable spacer includes one or more alignment pins for entering into the one or more alignment holes of the flat base thereby resisting slippage of the removable spacer adjacent the flat base.

11. The magnetic attachment assembly of claim 10, wherein the removable spacer includes a tray on a side of the removable space facing away from the winged insert, the tray having one or more other sidewalls for holding a metal plate.

12. The magnetic attachment assembly of claim 10, wherein the removable spacer is made of a non-magnetic material.

13. The magnetic attachment assembly of claim 10, further comprising:
one or more magnets mounted in the magnet holding holes of the flat base; and
a magnetic conductor adjacent the removable spacer;
wherein the removable spacer is sandwiched between the flat base and the magnetic conductor; and
the one or more magnets mounted in the magnet holding holes of the flat base and the magnetic conductor are pulled toward one another by an attractive magnetic property.

14. The magnetic attachment assembly of claim 13, wherein a thickness of the removable spacer does not prevent the attractive magnetic property between the one or more magnets and the magnetic conductor from overcoming forces of gravity on the magnetic conductor such that the magnetic conductor is magnetically held adjacent the flat base with the removable spacer therebetween.

15. A method of utilizing the magnetic attachment assembly of claim 13 for trim applications comprising:
inserting the magnetic attachment assembly into a slot of a trim board;
pushing the trim board toward a wall at a desired position such that an adhesive layer on a wall-facing side of the magnetic conductor attaches the magnetic conductor to the wall;
pulling the trim board away from the wall to thereby pull the winged insert away from the magnetic conductor;
removing the removable spacer from the magnetic attachment assembly; and
pushing the trim board toward the wall, whereby the attractive magnetic property of the one or more magnets pulls the winged insert against the magnetic conductor thereby attaching the trim board to the wall.

16. The method of claim 15, wherein a combined thickness of the winged insert and the magnetic conductor after the removable spacer has been removed is equal to a height of the slot such that the trim board sits directly against the wall.

17. A method of utilizing the magnetic attachment assembly of claim 10 for trim applications comprising affixing the magnetic conductor to a wall during an installation process before removing the removable spacer.

18. A winged insert comprising:
a flat base having a first side and a second side opposite the first side together forming a pair of opposing sides, the pair of opposing sides having a corresponding plurality of wings wherein each of the pair of opposing sides has a wing extending therefrom;
a first of the wings extending from the first side in a first direction and curving back in a first reverse direction at least partially opposite the first direction with a first outward-facing angle away from the flat base; and
a second of the wings extending from the second side in a second direction and curving back in a second reverse direction at least partially opposite the second direction with a second outward-facing angle away from the flat base;
wherein the flat base is rectangular having a length longer than a width; and
the first of the wings and the second of the wings respectively extend from the pair of opposing sides along the width of the flat base.

19. The winged insert of claim 18, wherein the flat base comprises one or more magnet holding holes for holding one or more magnets for providing an attractive magnetic force pulling the winged insert toward a magnetic conductor adjacent the flat base.

20. A method of utilizing the winged insert of claim 19 for flooring applications comprising:
inserting the winged insert into a slot of a flooring board;
attaching a joist clip having a top metal surface to a joist; wherein the magnetic conductor is the top metal surface of the joist clip; and
laying the flooring board on the joist such that the winged insert aligns with the joist clip, the one or more magnets in the winged insert thereby being attracted toward the top surface of the joist clip and holding the flooring board in position on the joist.
